(19) United States
(12) Patent Application Publication
(10) Pub. No.: US 2024/0220752 A1
(43) Pub. Date: Jul. 4, 2024

(54) Artificial Reality System for Code Recognition and Health Metrics

(71) Applicant: Meta Platforms Technologies, LLC, Menlo Park, CA (US)

(72) Inventors: Alexander FAABORG, Mountain View, CA (US); Joseph GARDNER, Burlingame, CA (US)

(21) Appl. No.: 18/605,162

(22) Filed: Mar. 14, 2024

Related U.S. Application Data
(60) Provisional application No. 63/499,356, filed on May 1, 2023.
(60) Provisional application No. 63/499,363, filed on May 1, 2023.

(51) Int. Cl. G06K 7/14; G06F 3/01; G06V 20/20; G06V 30/224; G06V 40/16

(52) U.S. Cl. CPC G06K 7/1417; G06F 3/011; G06F 3/017; G06V 20/20; G06V 30/224; G06V 40/172

(57) ABSTRACT

In some implementations, the disclosed systems and methods can be in sleep mode as its user traverses the real-world environment and can awaken upon a trigger, such as the wrist being raised (as detected, for example, by cameras or sensors on a smart wristband in communication with the XR device). In some implementations, the disclosed systems and methods can capture images of a user wearing the device while looking in the mirror.

### CROSS REFERENCE TO RELATED APPLICATIONS

This application claims priority to U.S. Provisional Application No. 63/499,356, filed on May 1, 2023, titled “I Artificial Reality System for Code Recognition and Health Metrics,” and U.S. Provisional Application No. 63/499,363, filed on May 1, 2023, titled “Facial Recognition-Triggered Display of Health Metrics on an Artificial Reality Device,” both of which are incorporated herein by reference in their entirety.

### BACKGROUND

Artificial reality (XR) devices are becoming more prevalent. As they become more popular, the applications implemented on such devices are becoming more sophisticated. Augmented reality (AR) applications can provide interactive 3D experiences that combine images of the real-world with virtual objects, while virtual reality (VR) applications can provide an entirely self-contained 3D computer environment. For example, an AR application can be used to superimpose virtual objects over a video feed of a real scene that is observed by a camera. A real-world user in the scene can then make gestures captured by the camera that can provide interactivity between the real-world user and the virtual objects. Mixed reality (MR) systems can allow light to enter a user's eye that is partially generated by a computing system and partially includes light reflected off objects in the real-world. AR, MR, and VR (together XR) experiences can be observed by a user through a head-mounted display (HMD), such as glasses or a headset. An MR HMD can have a pass-through display, which allows light from the real-world to pass through a waveguide that simultaneously emits light from a projector in the MR HMD, allowing the MR HMD to present virtual objects intermixed with real objects the user can actually see.

### SUMMARY

Aspects of the present disclosure are directed to quick response (QR) code recognition on an artificial reality (XR) device. The XR device can be in sleep mode as its user traverses the real-world environment and can awaken upon a trigger, such as the wrist being raised (as detected, for example, by cameras or sensors on a smart wristband in communication with the XR device). The XR device can then recognize a particular gesture being performed in relation to a QR code (e.g., framing the QR code with an L-shape with one hand), read the QR code, and open the content associated with the QR code.

Further aspects of the present disclosure are directed to triggering display of health metrics on an artificial reality (XR) device based on facial recognition. External facing cameras on the XR device can capture images of a user wearing the device while looking in the mirror. The XR device can perform facial recognition to determine that the user's face is being reflected in the mirror. The XR device can then add metrics, such as health metrics, around the view of the user's face. For example, a user can look at herself in the bathroom mirror, and see her sleep score. Thus, the user does not have to explicitly launch the metrics on the XR device, and the XR device can surface the metrics seamlessly throughout the day to keep the user apprised of her health.

### BRIEF DESCRIPTION OF THE DRAWINGS

FIG. 1A is a conceptual diagram of an example view of a user raising his wrist to activate an artificial reality device.

FIG. 1B is conceptual diagram of an example view on an artificial reality device of a user performing an L-shaped gesture with his hand relative to a QR code to scan the QR code with the artificial reality device.

FIG. 1C is a conceptual diagram of an example view on an artificial reality device of a user performing a pointing gesture with his hand relative to a QR code to scan the QR code with the artificial reality device.

FIG. 1D is a conceptual diagram of an example view on an artificial reality device of content displayed based on scanning of a QR code by the artificial reality device.

FIG. 2 is a flow diagram illustrating a process used in some implementations for recognizing quick response codes on an artificial reality device.

FIG. 3A is a conceptual diagram of an example view on smart glasses, of a user looking in a mirror, with health metrics for the user surrounding his face.

FIG. 3B is conceptual diagram illustrating an exemplary flow for facial recognition and health metrics retrieval by an artificial reality device according to some implementations of the present technology.

FIG. 4 is a flow diagram illustrating a process used in some implementations for triggering display of metrics for a user on an artificial reality device based on facial recognition.

FIG. 5 is a block diagram illustrating an overview of devices on which some implementations of the present technology can operate.

FIG. 6 is a block diagram illustrating an overview of an environment in which some implementations of the present technology can operate.

### DESCRIPTION

Aspects of the present disclosure are directed to quick response (QR) code recognition on an artificial reality (XR) device. As a user walks around her real-world environment wearing her XR device, the XR device can remain in a standby mode, conserving battery power. The XR device can detect a wakeup trigger, such as a user making a particular gesture such as raising her hand above a threshold or speaking a phrase, etc. In some cases, the wakeup trigger can be detected via cameras or other sensors in an HMD or via a wearable device (e.g., a smart wristband in communication with the XR device). The XR device can then detect (e.g., via one or more cameras integral with the XR device or sensors in a wearable band) that the user is making a particular gesture with her hand and that the gestures is being performed relative to a QR code, such as by making a C-shape with her hand around the QR code. Based on the detected gesture, the XR device can then read the QR code, and open the content designated by the QR code. Thus, the XR device can scan only the QR code that is intended to be interacted with by the user, as indicated by her gesture relative to the QR code, and can disregard other QR codes that may be in the field-of-view of the XR device.

Although this application discusses QR codes, other codes are contemplated and can be substituted for QR codes in the described embodiments, such as bar codes, URLs, email addresses, addresses, phone numbers, user IDs or handles, metaverse location addresses, etc. In some cases, the action the system takes can depend on the type of code scanned—for example, a scanned email address can open a messaging application with the email address filled in, a phone number can start a call to the indicated number, an address can start a mapping application with the address selected, etc.

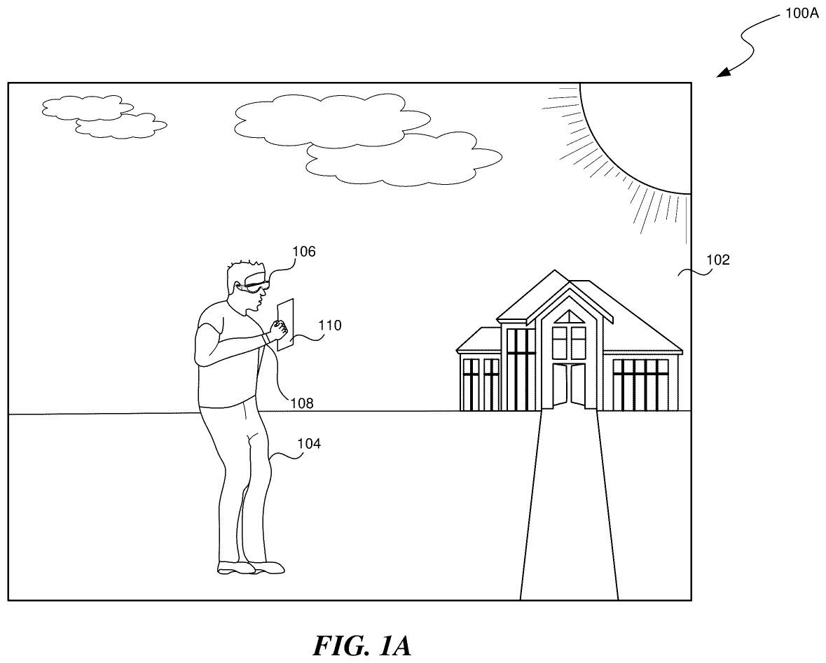

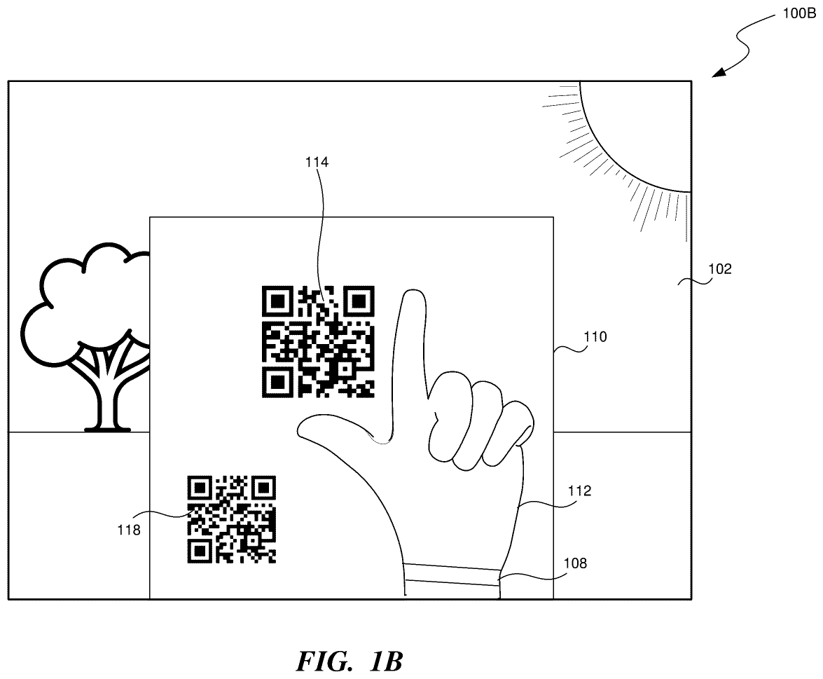

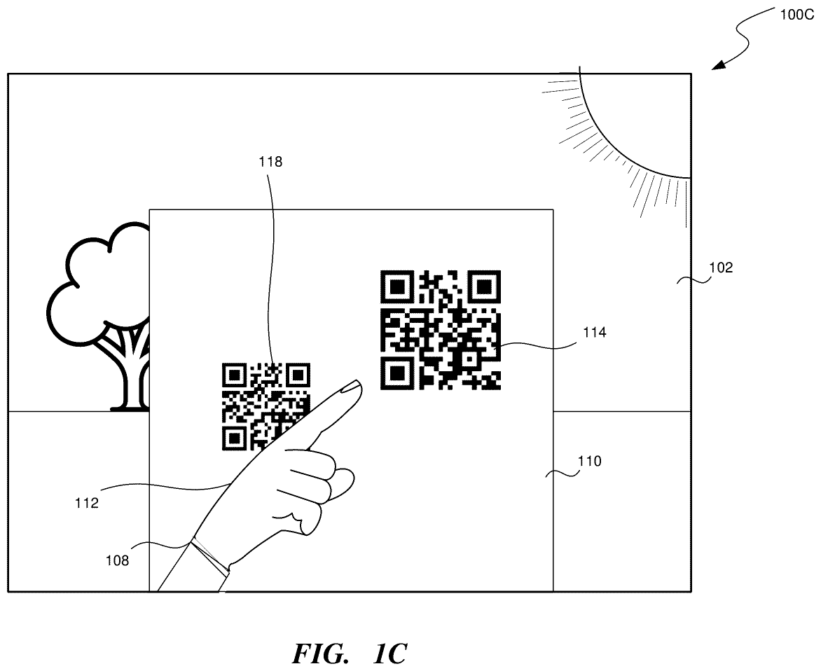

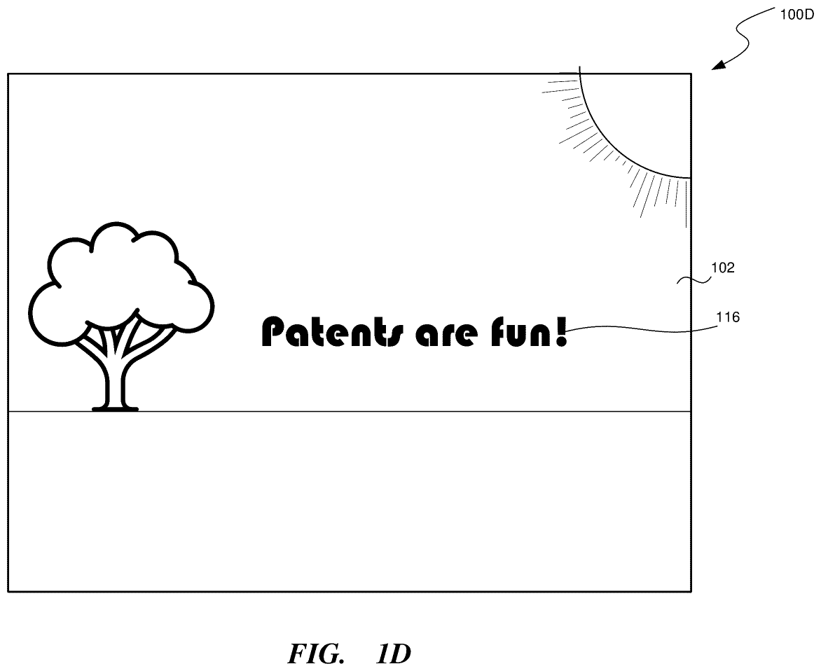

FIG. 1A is a conceptual diagram of an example view 100A of a user 104, in real-world environment 102, raising his wrist to activate an artificial reality (XR) device 106. User 104 can hold up a paper 110 having a quick response (QR) code 114 that can be scanned by XR device 106. Smart wristband 108, worn by user 104, can detect user 104 raising his wrist through, for example, one or more sensors of an inertial measurement unit (IMU) (e.g., an accelerometer, a gyroscope, etc.), and/or one or more electromyography (EMG) sensors, as described further herein. In some implementations, smart wristband 108 can transmit an indication to XR device 106 that user 104 has raised his wrist. In response to receiving the indication, XR device 106 can enter into an active mode from a standby mode, and begin to capture images (e.g., through one or more cameras integral with XR device 106).

FIG. 1B is conceptual diagram of an example view 100B on an artificial reality (XR) device 106 of a user 104 performing an L-shaped gesture with his hand 112, in real-world environment 102, relative to a quick response (QR) code 114, to scan the QR code 114 with the XR device 106. Once XR device 106 is awakened from a standby mode, XR device 106 can activate its cameras to capture example view 100B. Paper 110 can include QR code 114 that user 104 can desire to scan. Thus, user 104 can use his hand 112 to perform a gesture relative to QR code 114, i.e., an L-shaped gesture, which XR device 106 can, in some implementations, detect by capturing an image of hand 112 and performing object recognition. The L-shaped gesture being performed relative to QR code 114 can, in some implementations, be interpreted by XR device 106 as an instruction to scan QR code 114. XR device 106 can disregard QR code 118 (i.e., not scan QR code 118), which is not indicated by the L-shaped gesture of hand 112.

FIG. 1C is a conceptual diagram of an example view 100C on an artificial reality (XR) device 106 of a user 104 performing a pointing gesture with his hand 112, in real-world environment 102, relative to a quick response (QR) code 114, to scan the QR code 114 with the XR device 106. Similar to that described with respect to FIG. 1B, user 104 can use his hand 112 to perform a gesture relative to QR code 114, i.e., a pointing gesture, which XR device 106 can, in some implementations, detect by capturing an image of hand 112 and performing object recognition. In this example, the pointing gesture being performed relative to QR code 114 can be interpreted by XR device 106 as an instruction to scan QR code 114. XR device 106 can disregard QR code 118 (i.e., not scan QR code 118), which is not indicated by the pointing gesture of hand 112. Although described herein with respect to FIG. 1B and FIG. 1C as making an L-shaped gesture and pointing gesture, respectively, to cause XR device 106 to scan QR code 114, it is contemplated that any suitable gesture can be recognized by XR device 106 to cause scanning of QR code 114, such as a C- or circle-shaped gesture around QR code 114, a movement of the hand and/or fingers around QR code 114, a tapping gesture on QR code 114, a pinching gesture around QR code 114, etc.

FIG. 1D is a conceptual diagram of an example view 100D on an artificial reality (XR) device 106 of content 116 based on scanning of a quick response (QR) code 114 by the XR device 106. From example view 100B and/or example view 100C, XR device 106 can scan and interpret QR code 114, which can be encoded with text in this example (e.g., “Patents are fun!”). Based on the text encoded in QR code 114, XR device 106 can display content 116, which is visually indicating the text encoded in QR code 114. In some implementations, such as in mixed reality (MR) or augmented reality (AR), XR device 106 can display content 116 as an overlay on a view of real-world environment 102.

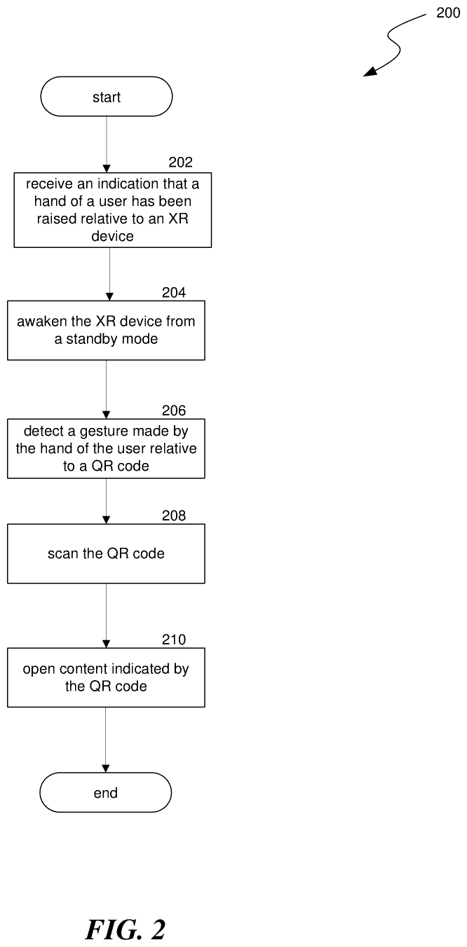

FIG. 2 is a flow diagram illustrating a process 200 used in some implementations for recognizing quick response (QR) codes on an artificial reality (XR) device. In some implementations, process 200 can be performed as a response to receiving an indication and/or detecting that a hand of a user of the XR device has been raised. In some implementations, process 200 can be partially or fully performed by the XR device, such as an XR head-mounted display (HMD). In some implementations, process 200 can be partially or fully performed by an XR device other than an XR HMD, such as separate processing components.

At block 202, process 200 can receive an indication of a wake command—e.g., that a hand, of a user of the XR device, has been raised relative to the XR device, that a fist has been formed, that some other gesture has been made, that a wake phrase has been spoken, etc. In some implementations, process 200 can receive measurements from one or more sensors of an inertial measurement unit (IMU) integral with or in operable communication with the XR device (e.g., in a smart device, such as a smart wristband or smart ring, or controller in communication with the XR device), to identify and/or confirm one or more motions of the user indicative of the wake command. The measurements may include the non-gravitational acceleration of the device in the x, y, and z directions; the gravitational acceleration of the device in the x, y, and z directions; the yaw, roll, and pitch of the device; the derivatives of these measurements; the gravity difference angle of the device; and the difference in normed gravitational acceleration of the device. In some implementations, the movements of the device may be measured in intervals, e.g., over a period of 5 seconds. For example, when motion data is captured by a gyroscope and/or accelerometer in an IMU of a smart wristband, process 200 (or the smart wristband) can analyze the motion data to identify features or patterns indicative of the wake command, such as the user raising his hand, as trained by a machine learning model. In some implementations, the machine learning model can be trained on stored movements that are known or confirmed to be associated with users raising their hands.

In some implementations, process 200 (or the smart wristband) can receive measurements from one or more electromyography (EMG) sensors integral with or in operable communication with the XR device, such as on an EMG wristband, to identify and/or confirm one or more motions of the user indicative of the wake command. Process 200 can determine that the hand has been put into a particular pose by, for example, analyzing a waveform indicative of electrical activity of one or more muscles of the user using the EMG sensors. Process 200 (or the smart wristband) can analyze the waveform captured by the EMG sensors worn by the user by, for example, identifying features within the waveform and generating a signal vector indicative of the features. In some implementations, process 200 (or the smart wristband) can compare the signal vector to known vectors, indicative of hand raising, stored in a database to identify if any of the known vectors matches the signal vector within a threshold, e.g., is within a threshold distance of a known threshold vector (e.g., the signal vector and a known vector have an angle therebetween that is lower than a threshold angle). If a known vector matches the signal vector within the threshold, process 200 (or the smart wristband) can determine that the user made the wake command.

At block 204, process 200 can awaken the XR device from a standby or “sleep” mode. In some implementations, to conserve battery power, the XR device can remain in a standby mode, while the user traverses his real-world environment, until awakened by the user. For example, the XR device can be awakened based on the user raising her hand, as detected by a wearable device, which can transmit measurements indicative of hand raising and/or an instruction to “wake up” to the XR device. In the standby mode, the camera(s) of the XR device can be disabled.

At block 206, process 200 can detect a gesture made by one or more fingers and/or the hand, of the user of the XR device, relative to a QR code. In some implementations, process 200 can detect the gesture via the wearable device—e.g., using the EMG pose determining features discussed above. In some implementations, process 200 can detect the gesture via one or more cameras integral with or in operable communication with the XR device, such as cameras positioned on an XR HMD pointed away from the user's face, e.g., toward the user's hand(s). For example, process 200 can capture one or more images of the user's hand/or fingers in front of the XR device while making a particular gesture. Process 200 can perform object recognition on the captured image(s) to identify a user's hand and/or fingers making a particular gesture (e.g., an L-shaped gesture, a C-shaped gesture, a two-handed goal post gesture, pointing, etc.).

In some implementations, process 200 can use a machine learning model to identify the gesture from the image(s). For example, process 200 can train a machine learning model with images capturing known gestures, such as images showing a user's finger pointing, a user making a sign with her fingers, etc. Process 200 can identify relevant features in the images, such as edges, curves, and/or colors indicative of fingers, a hand, etc., making a particular gesture. Process 200 can train a machine learning model using these relevant features of known gestures. Once the model is trained with sufficient data, process 200 can use the trained model to identify relevant features in newly captured image(s) and compare them to the features of known gestures. In some implementations, process 200 can use the trained model to assign a match score to the newly captured image(s), e.g., 80%. If the match score is above a threshold, e.g., 70%, process 200 can classify the motion captured by the image(s) as being indicative of a particular gesture. In some implementations, process 200 can further receive feedback from the user regarding whether the identification of the gesture was correct (and/or whether the QR code should have been scanned at block 208 described herein), and update the trained model accordingly. Alternatively or additionally, process 200 can identify and/or confirm the gesture using one or more sensors of an IMU and/or one or more EMG sensors, e.g., on a smart wristband, as described further herein. Process 200 can further determine whether the gesture was made relative to a QR code by, for example, searching the captured image(s) and recognizing a QR code in proximity to the gesture, e.g., within a threshold distance, such as 2 inches.

At block 208, process 200 can, in response to detecting the gesture made by the hand, scan the QR code. Process 200 can scan the QR code using an imaging device, such as a camera, to visually capture the code. Once the QR code is visually captured, process 200 can perform Reed-Solomon error correction, for example, until the image can be interpreted, and data encoded in the QR code can be extracted,

At block 210, process 200 can open the content, on the XR device, indicated by the QR code. In other words, once the encoded data has been extracted from the QR code, it can be rendered on the XR device. For example, the QR code can include text and/or an identifier that points to an image, a file, a website, an application, etc. Process 200 can access the text and/or the identifier (e.g., via a web browser), and render such content on the XR device.

Although illustrated herein as process 200 including blocks 202-210, it is contemplated that, in some implementations, it is not necessary to perform blocks 202-204. For example, it is contemplated that the XR device may not be in standby mode when a gesture is made relative to a QR code at block 206. Similarly, it is contemplated that one or more cameras of the XR device may already be active and capable of capturing images of the user's hand and/or the QR code at block 206. In some implementations, therefore, it is contemplated that a wearable device, such as a smart wristband, need not be worn by the user to capture raising of the hand to awaken the XR device.

Aspects of the present disclosure are directed to triggering display of health metrics on an artificial reality (XR) device based on facial recognition. One or more cameras integral with the XR device, facing away from its user, can capture images of the user's face in a mirror. The XR device can perform facial recognition to determine that the face is of the user of the XR device, such as by comparing features of captured facial images to known facial images of the user. The XR device can then add metrics, such as health metrics, around the view of the user's face. For example, a user can look at himself in a full-length mirror, and see his weight, height, activity level, number of steps taken that day, etc. Thus, the user does not have to actively launch an XR experience for displaying the metrics. Further, the ambient display of the metrics can assist in consistent discovery of the information throughout the day, and keep the user motivated to reach health and fitness goals.

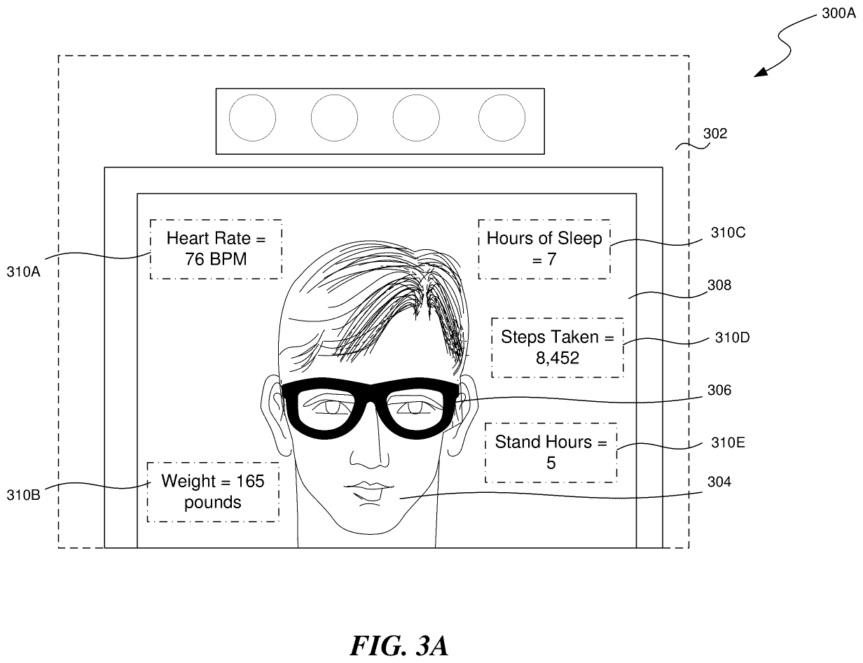

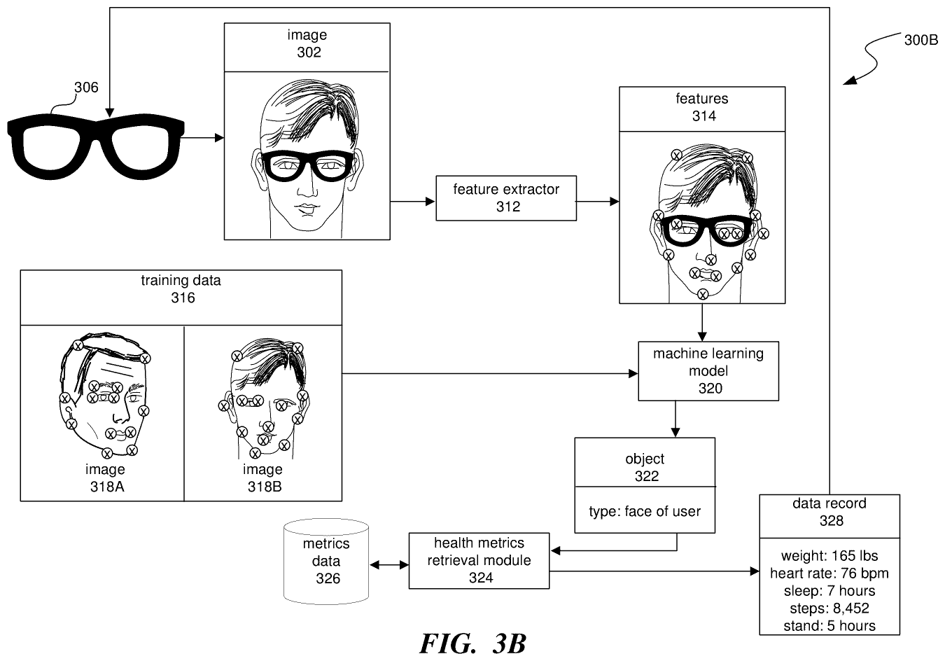

FIG. 3A is a conceptual diagram of an example view 300A on smart glasses 306, of a user looking in a mirror 308, with health metrics 310A-310E for the user surrounding his face 304 in real-world environment image 302. Smart glasses 306 can capture, via one or more outward facing cameras (not shown), one or more images including face 304 of the user of smart glasses 306. In some implementations, smart glasses 306 can perform object detection, object recognition, and/or facial recognition techniques to identify face 304 of the user in particular from the images, or to identify face 304 generally in conjunction with mirror 308, thereby inferring that face 304 is of the particular user. In response to identifying face 304 of the user from image 302, smart glasses 306 can display health metrics 310A-310E associated with the user; for example, metric 310A indicating a heart rate of the user, metric 310B indicating a weight of the user, metric 310C indicating a number of hours of sleep of the user, metric 310D indicating a number of steps taken by the user, and metric 310E indicating a number of hours in the day the user has been standing. Although shown and described relative to particular health metrics 310A-310E, it is contemplated that any of a number of other health metrics or non-health metrics can be displayed on smart glasses 306, examples of which are provided herein.

FIG. 3B is a conceptual diagram illustrating an exemplary flow 300B for facial recognition and health metrics retrieval by an artificial reality device according to some implementations of the present technology. Smart glasses 306 can capture image 302; in this case, an image of a face of a user of smart glasses 306. Smart glasses 306 can be an XR HMD in some implementations. Image 302 can be fed into feature extractor 312 that can identify relevant features 314 in image 302. Relevant features 314 can correspond to, for example, edges, corners, shapes, curvatures, colors, or textures, or any combination thereof. Relevant features 314 can be fed into machine learning model 320.

Machine learning model 320 can obtain training data 316 including labeled faces of the user with identified features; for example, in image 318A of the user's face and image 318B of the same user's face. Machine learning model 320 can compare relevant features 314 to training data 316 to determine a match score between relevant features 314 and training data 316. In this case, machine learning model 320 can determine that the face in image 302 has a match score above a threshold with training data 316, i.e., is the face of the same user as in images 318A and 318B.

Machine learning model 320 can output data 322 indicating that image 302 is of the face of the user, which can be fed into health metrics retrieval module 324. Health metrics retrieval module 324 can obtain metrics data 326 associated with the user. Health metrics retrieval module 324 can output data record 328 identifying various health metrics, e.g., metrics 310A-310E, to smart glasses 306. Smart glasses 306 can display data record 328, or any derivative thereof, in any suitable means, such as textually or graphically (e.g., as an icon, graph, etc.), alongside statistics and goals, in some implementations. In some implementations, smart glasses 306 can provide feedback to machine learning model 320 regarding whether the face was identified correctly in image 302, such as based on whether the user allows the display of data record 328 to continue (which can imply that the face was correctly identified in some implementations), or to terminate the display of data record 328 (which can imply that the face was incorrectly identified in some implementations).

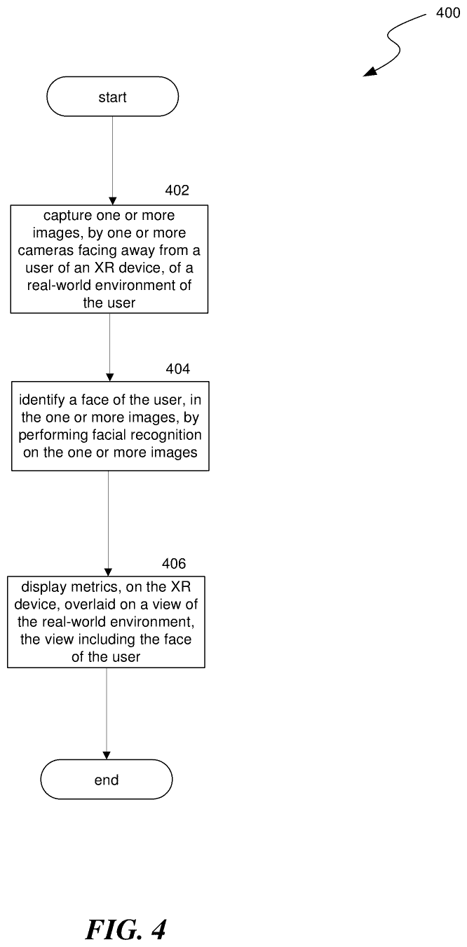

FIG. 4 is a flow diagram illustrating a process 400 used in some implementations for triggering display of metrics for a user on an artificial reality (XR) device based on facial recognition. In some implementations, process 400 can be performed as a response to activation, donning, or awakening of the XR device. In some implementations, process 400 can be performed as a response to detection of a user of the XR device entering a particular physical space, e.g., a bathroom or other room likely to have a mirror. In some implementations, process 400 can detect that the user of the XR device has entered the particular physical space by capturing and/or accessing one or more spatial anchors and/or one or more guardians (e.g., previously captured and labeled physical boundaries) established for the physical space. In some implementations, process 400 can be performed as a response to a user request to capture images on the XR device. In some implementations, process 400 can be performed by the XR device. In some implementations, some or all of process 400 can be performed by an XR head-mounted display (HMD), XR glasses, and/or XR headset, which are used interchangeably herein. In some implementations, some or all of process 400 can be performed by one or more other XR devices in operable communication with an XR HMD, such as an external camera, external processing components, etc.

At block 402, process 400 can capture one or more images of a real-world environment of the user. In some implementations, the one or more images can be captured by one or more cameras integral with or in operable communication with the XR device. The one or more cameras can include at least one camera facing away from the user of the XR device. In some implementations, the one or more images can be a stream of images, such as a video.

At block 404, process 400 can identify a face of the user, in the one or more captured images, by performing facial recognition on the one or more images. In some implementations, process 400 can perform facial recognition (e.g., object detection and/or recognition) on the face to determine that it is the particular face of the user (as opposed to the face of another user). In some implementations, process 400 can perform facial recognition (e.g., object detection and/or recognition) on the one or more images to determine generally that a face is present in the one or more images, then perform object detection and/or recognition to determine that is a mirror is in front of the XR device, thereby inferring that the face is of the particular user of the XR device. By identifying that a mirror is front of the XR device, process 400 can exclude other reflections of the user's face in some implementations (e.g., a reflection on a window). In some implementations, process 400 can perform facial recognition, object detection, and/or object recognition by comparing known features of faces (or a particular face) to the face captured by the XR device, as described further herein. In some implementations, while performing facial recognition, process 400 can display a virtual object indicating that the face is being scanned, such as by putting a virtual frame or pulsing light around the face. In some implementations, upon positively identifying the face of the user in the captured images, process 400 can delete the captured images from storage.

At block 406, process 400 can, in response to identifying the face of the user, display metrics overlaid on a view of the real-world environment, such as in mixed reality (MR) or augmented reality (AR). The view can include the face, e.g., a reflection of the face in a mirror. In some implementations, process 400 can alternatively or additionally prompt the user to display one or more metrics upon identification of the face of the user. In some implementations, the metrics can be metrics that are individualized for the user. For example, the metrics can include health metrics, e.g., weight, heart rate, blood oxygen level, hours of sleep, number of steps taken, number of stand hours, number of calories consumed, number of calories burned, time spent exercising, scores and/or graphs over time thereof, medication schedules, and/or the like.

In some implementations, process 400 can obtain the metrics via the XR device, e.g., using one or more sensors of an inertial measurement unit (IMU), using one or more cameras integral with or in operable communication with the XR device, etc., in order to track the health-related activities of the user. In some implementations, process 400 can obtain the metrics from a wearable device in operable communication with the XR device, such as a smart wristband or smart watch tracking activity- and health-related metrics. In some implementations, process 400 can obtain the metrics by making application programming interface (API) calls to one or more applications executing on the XR device (or another device in operable communication with the XR device, such as a mobile phone) for activity- and health-related data, such as applications for tracking food intake, counting calories, recording fitness routines, etc.

Although described primarily herein as identifying the face of the user as a trigger to display metrics, it is contemplated, however, that viewing other objects on the XR device can be an alternative trigger. For example, viewing a bed through the XR device can trigger display of sleep metrics. In another example, viewing a car through the XR device can trigger display of traffic and driving metrics. In another example, viewing a television through the XR device can trigger display of viewing metrics by the user, recommended programming, etc.

Although primarily described herein as relating to health metrics, however, it is contemplated that any data and/or information relevant to the user, his environment, or the XR device can be displayed on the XR device based on recognition of the user's face. For example, the XR device can display environmental conditions, such as time of day, date, weather, etc. In another example, the XR device can display metrics related to the XR device, such as available battery power, menus of features or experiences available on the XR device, etc. In some implementations, the metrics displayed on the XR device in response to detecting the user's face can be user customizable.

In some implementations, process 400 can end when the XR device no longer captures images of the user's face, i.e., when the user walks away from a mirror. In some implementations, process 400 can end after a predefined period of time, e.g., 1 minute. In some implementations, process 400 can end when the user removes or deactivates the XR device, or places it in a low-powered sleep or standby mode in which the cameras and/or the display are no longer executing.

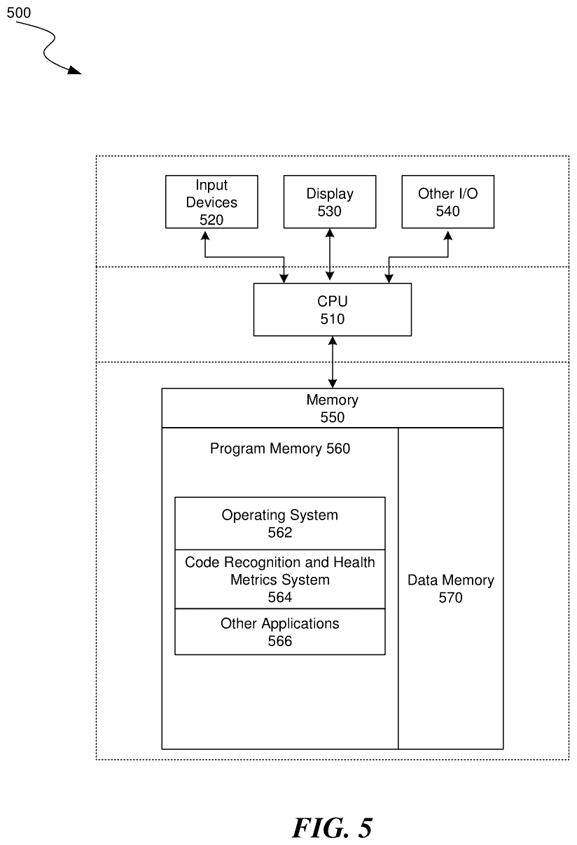

FIG. 5 is a block diagram illustrating an overview of devices on which some implementations of the disclosed technology can operate. The devices can comprise hardware components of a device 500 as shown and described herein. Device 500 can include one or more input devices 520 that provide input to the Processor(s) 510 (e.g., CPU(s), GPU(s), HPU(s), etc.), notifying it of actions. The actions can be mediated by a hardware controller that interprets the signals received from the input device and communicates the information to the processors 510 using a communication protocol. Input devices 520 include, for example, a mouse, a keyboard, a touchscreen, an infrared sensor, a touchpad, a wearable input device, a camera- or image-based input device, a microphone, or other user input devices.

Processors 510 can be a single processing unit or multiple processing units in a device or distributed across multiple devices. Processors 510 can be coupled to other hardware devices, for example, with the use of a bus, such as a PCI bus or SCSI bus. The processors 510 can communicate with a hardware controller for devices, such as for a display 530. Display 530 can be used to display text and graphics. In some implementations, display 530 provides graphical and textual visual feedback to a user. In some implementations, display 530 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 540 can also be coupled to the processor, such as a network card, video card, audio card, USB, firewire or other external device, camera, printer, speakers, CD-ROM drive, DVD drive, disk drive, or Blu-Ray device.

In some implementations, the device 500 also includes a communication device capable of communicating wirelessly or wire-based with a network node. The communication device can communicate with another device or a server through a network using, for example, TCP/IP protocols. Device 500 can utilize the communication device to distribute operations across multiple network devices.

The processors 510 can have access to a memory 550 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 550 can include program memory 560 that stores programs and software, such as an operating system 562, Code Recognition and Health Metrics System 564, and other application programs 566. Memory 550 can also include data memory 570, which can be provided to the program memory 560 or any element of the device 500.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

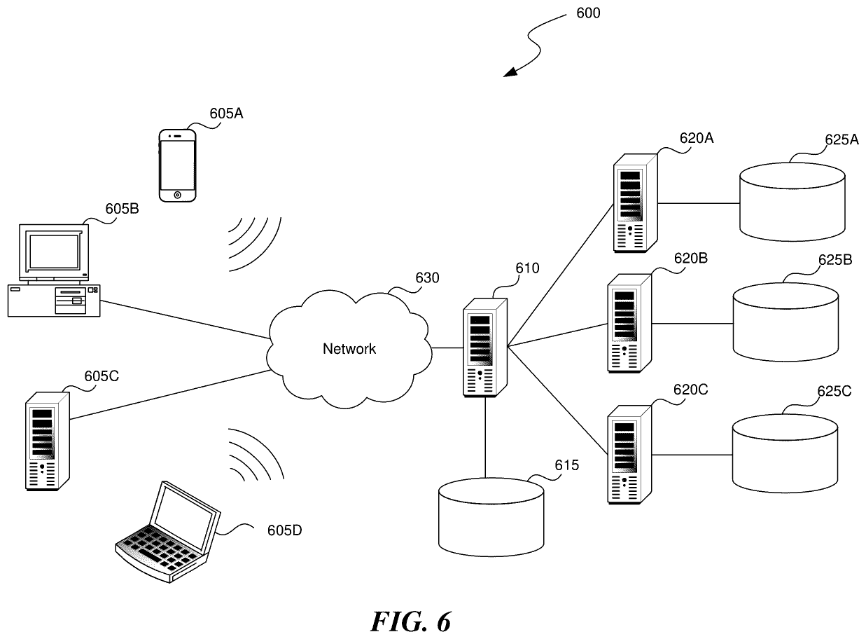

FIG. 6 is a block diagram illustrating an overview of an environment 600 in which some implementations of the disclosed technology can operate. Environment 600 can include one or more client computing devices 605A-D, examples of which can include device 500. Client computing devices 605 can operate in a networked environment using logical connections through network 630 to one or more remote computers, such as a server computing device.

In some implementations, server 610 can be an edge server which receives client requests and coordinates fulfillment of those requests through other servers, such as servers 620A-C. Server computing devices 610 and 620 can comprise computing systems, such as device 500. Though each server computing device 610 and 620 is displayed logically as a single server, server computing devices can each be a distributed computing environment encompassing multiple computing devices located at the same or at geographically disparate physical locations. In some implementations, each server 620 corresponds to a group of servers.

Client computing devices 605 and server computing devices 610 and 620 can each act as a server or client to other server/client devices. Server 610 can connect to a database 615. Servers 620A-C can each connect to a corresponding database 625A-C. As discussed above, each server 620 can correspond to a group of servers, and each of these servers can share a database or can have their own database. Databases 615 and 625 can warehouse (e.g., store) information. Though databases 615 and 625 are displayed logically as single units, databases 615 and 625 can each be a distributed computing environment encompassing multiple computing devices, can be located within their corresponding server, or can be located at the same or at geographically disparate physical locations.

Network 630 can be a local area network (LAN) or a wide area network (WAN), but can also be other wired or wireless networks. Network 630 may be the Internet or some other public or private network. Client computing devices 605 can be connected to network 630 through a network interface, such as by wired or wireless communication. While the connections between server 610 and servers 620 are shown as separate connections, these connections can be any kind of local, wide area, wired, or wireless network, including network 630 or a separate public or private network.

In some implementations, servers 610 and 620 can be used as part of a social network. The social network can maintain a social graph and perform various actions based on the social graph. A social graph can include a set of nodes (representing social networking system objects, also known as social objects) interconnected by edges (representing interactions, activity, or relatedness). A social networking system object can be a social networking system user, nonperson entity, content item, group, social networking system page, location, application, subject, concept representation or other social networking system object, e.g., a movie, a band, a book, etc. Content items can be any digital data such as text, images, audio, video, links, webpages, minutia (e.g., indicia provided from a client device such as emotion indicators, status text snippets, location indictors, etc.), or other mufti-media. In various implementations, content items can be social network items or parts of social network items, such as posts, likes, mentions, news items, events, shares, comments, messages, other notifications, etc. Subjects and concepts, in the context of a social graph, comprise nodes that represent any person, place, thing, or idea.

A social networking system can enable a user to enter and display information related to the user's interests, age/date of birth, location (e.g., longitude/latitude, country, region, city, etc.), education information, life stage, relationship status, name, a model of devices typically used, languages identified as ones the user is facile with, occupation, contact information, or other demographic or biographical information in the user's profile. Any such information can be represented, in various implementations, by a node or edge between nodes in the social graph. A social networking system can enable a user to upload or create pictures, videos, documents, songs, or other content items, and can enable a user to create and schedule events. Content items can be represented, in various implementations, by a node or edge between nodes in the social graph.

A social networking system can enable a user to perform uploads or create content items, interact with content items or other users, express an interest or opinion, or perform other actions. A social networking system can provide various means to interact with non-user objects within the social networking system. Actions can be represented, in various implementations, by a node or edge between nodes in the social graph. For example, a user can form or join groups, or become a fan of a page or entity within the social networking system. In addition, a user can create, download, view, upload, link to, tag, edit, or play a social networking system object. A user can interact with social networking system objects outside of the context of the social networking system. For example, an article on a news web site might have a “like” button that users can click. In each of these instances, the interaction between the user and the object can be represented by an edge in the social graph connecting the node of the user to the node of the object. As another example, a user can use location detection functionality (such as a GPS receiver on a mobile device) to “check in” to a particular location, and an edge can connect the user's node with the location's node in the social graph.

A social networking system can provide a variety of communication channels to users. For example, a social networking system can enable a user to email, instant message, or text/SMS message, one or more other users. It can enable a user to post a message to the user's wall or profile or another user's wall or profile. It can enable a user to post a message to a group or a fan page. It can enable a user to comment on an image, wall post or other content item created or uploaded by the user or another user. And it can allow users to interact (e.g., via their personalized avatar) with objects or other avatars in an artificial reality environment, etc. In some embodiments, a user can post a status message to the user's profile indicating a current event, state of mind, thought, feeling, activity, or any other present-time relevant communication. A social networking system can enable users to communicate both within, and external to, the social networking system. For example, a first user can send a second user a message within the social networking system, an email through the social networking system, an email external to but originating from the social networking system, an instant message within the social networking system, an instant message external to but originating from the social networking system, provide voice or video messaging between users, or provide an artificial reality environment were users can communicate and interact via avatars or other digital representations of themselves. Further, a first user can comment on the profile page of a second user, or can comment on objects associated with a second user, e.g., content items uploaded by the second user.

Social networking systems enable users to associate themselves and establish connections with other users of the social networking system. When two users (e.g., social graph nodes) explicitly establish a social connection in the social networking system, they become “friends” (or, “connections”) within the context of the social networking system. For example, a friend request from a “John Doe” to a “Jane Smith,” which is accepted by “Jane Smith,” is a social connection. The social connection can be an edge in the social graph. Being friends or being within a threshold number of friend edges on the social graph can allow users access to more information about each other than would otherwise be available to unconnected users. For example, being friends can allow a user to view another user's profile, to see another user's friends, or to view pictures of another user. Likewise, becoming friends within a social networking system can allow a user greater access to communicate with another user, e.g., by email (internal and external to the social networking system), instant message, text message, phone, or any other communicative interface. Being friends can allow a user access to view, comment on, download, endorse or otherwise interact with another user's uploaded content items. Establishing connections, accessing user information, communicating, and interacting within the context of the social networking system can be represented by an edge between the nodes representing two social networking system users.

In addition to explicitly establishing a connection in the social networking system, users with common characteristics can be considered connected (such as a soft or implicit connection) for the purposes of determining social context for use in determining the topic of communications. In some embodiments, users who belong to a common network are considered connected. For example, users who attend a common school, work for a common company, or belong to a common social networking system group can be considered connected. In some embodiments, users with common biographical characteristics are considered connected. For example, the geographic region users were born in or live in, the age of users, the gender of users and the relationship status of users can be used to determine whether users are connected. In some embodiments, users with common interests are considered connected. For example, users' movie preferences, music preferences, political views, religious views, or any other interest can be used to determine whether users are connected. In some embodiments, users who have taken a common action within the social networking system are considered connected. For example, users who endorse or recommend a common object, who comment on a common content item, or who RSVP to a common event can be considered connected. A social networking system can utilize a social graph to determine users who are connected with or are similar to a particular user in order to determine or evaluate the social context between the users. The social networking system can utilize such social context and common attributes to facilitate content distribution systems and content caching systems to predictably select content items for caching in cache appliances associated with specific social network accounts.

Embodiments of the disclosed technology may include or be implemented in conjunction with an artificial reality system. Artificial reality or extra reality (XR) is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof. Additional details on XR systems with which the disclosed technology can be used are provided in U.S. patent application Ser. No. 17/170,839, titled “INTEGRATING ARTIFICIAL REALITY AND OTHER COMPUTING DEVICES,” filed Feb. 8, 2021 and now issued as U.S. Pat. No. 11,402,964 on Aug. 2, 2022, which is herein incorporated by reference.

Those skilled in the art will appreciate that the components and blocks illustrated above may be altered in a variety of ways. For example, the order of the logic may be rearranged, substeps may be performed in parallel, illustrated logic may be omitted, other logic may be included, etc. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc. Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/we claim:

1. A method for recognizing quick response codes on an artificial reality device, the method comprising:
receiving, from a wearable device, an indication that a hand, of a user of the artificial reality device, has formed a gesture corresponding to a wake command;
awakening the artificial reality device from a standby mode;
detecting a gesture made by the hand, of the user of the artificial reality device, relative to a quick response code;
in response to detecting the gesture made by the hand, scanning the quick response code; and
opening content, on the artificial reality device, indicated by the quick response code.

2. A method for triggering display of metrics for a user on an artificial reality device based on facial recognition, the method comprising:
capturing one or more images, by one or more cameras facing away from the user of the artificial reality device, of a real-world environment of the user;
identifying a face of the user, in the one or more images, by performing facial recognition on the one or more images; and
based identifying the face of the user, displaying the metrics on the artificial reality device overlaid on a view of the real-world environment, the view including the face of the user.

3. A computer-readable storage medium storing instructions that, when executed by a computing system, cause the computing system to perform a process as shown and described herein.
